(19) United States
(12) Patent Application Publication
(10) Pub. No.: US 2011/0123243 A1
(43) Pub. Date: May 26, 2011

(54) Image forming apparatus

(75) Inventor: Shuhji Fujii, Osaka (JP)

(73) Assignee: Sharp Kabushiki Kaisha, Osaka (JP)

(21) Appl. No.: 12/927,440

(22) Filed: Nov. 12, 2010

(30) Foreign Application Priority Data
Nov. 20, 2009 (JP) JP2009-265205

(51) Int. Cl. B41J 11/44

(52) U.S. Cl. 400/76

(57) ABSTRACT

As one embodiment, in an image forming apparatus (1), identification information of a screen for assisting a setting of a process that was last executed immediately prior to powering off is stored in a nonvolatile memory of a control unit (11), and when the power is turned on, at least one functional unit required to execute the process of this screen is determined from the identification information of the screen stored in the nonvolatile memory, and this functional unit is activated.

### CROSS-REFERENCE TO RELATED APPLICATIONS

This application claims priority under 35 U.S.C. §119(a) on Patent Application No. 2009-265205 filed in Japan on Nov. 20, 2009, the entire contents of which are herein incorporated by reference.

### BACKGROUND OF THE INVENTION

The present invention relates to image forming apparatuses that aim to achieve power savings.

Conventionally, multifunction machines are available as image forming apparatuses that selectively execute various types of processing such as copying, original reading, printing, and image data communications.

Since the power consumption of these multifunction machines inevitably increases, one consideration thereof is to aim to achieve power savings. For example, since there is large power consumption in a printing unit that executes print processing on a recording paper, a power-saving mode is set in which a standby time of the image forming apparatus is timed, and when the standby time exceeds a fixed time, the power consumption of the printing unit is reduced, or when the standby time becomes too long, the power of the printing unit is turned off, or further still the power of other functional units is also turned off.

For example, in JP 2006-333059A, when returning from a power-saving mode, only a functional unit that executes a process instructed by an operation at an operation unit is activated, thereby reducing power consumption. For example, if reading of an original is instructed by an operation at the operation unit, only the original scanner is activated, and units such as the printing unit that are not required for reading the original are not activated, thereby reducing power consumption.

However, in conventional image forming apparatuses, all functional units such as the original scanner, the printing unit, a communications unit, and a modem and the like are activated when the power of the image forming apparatus is turned on, and therefore the power consumption is increased to no purpose when the power is turned on.

Also, even in JP 2006-333059A described above, power consumption is reduced only when returning from the power-saving mode, and all functional units are activated when the power of the image forming apparatus is turned on, and therefore this does not extend to reducing the power consumption when the power is turned on.

### SUMMARY OF THE INVENTION

The present invention has been devised to address the above-described issues, and it is an object thereof to provide an image forming apparatus that is capable of reducing wasteful power consumption when the power is turned on.

In order to address these issues, the present invention is directed to an image forming apparatus provided with multiple functional units, wherein working and non-working of the functional units are switched and set, and the image forming apparatus is provided with a storage means for storing, among the functional units, the functional unit that was working immediately prior to power of the image forming apparatus being turned off, and a control means for activating the functional unit stored in the storage means when power of the image forming apparatus is turned on.

For example, in a case where an original scanner (a functional unit) is working immediately prior to the power of the image forming apparatus being turned off, the original scanner is stored in the storage means, and the original scanner is activated when the image forming apparatus is powered on. In this way, functional units estimated to have a high usage frequency are selectively activated, and increases in power consumption can be suppressed.

Furthermore, when the power of the image forming apparatus is turned on, the control means prohibits activation of other functional units excluding the functional unit stored in the storage means.

In this way, functional units estimated to have a low usage frequency are not activated, and wasteful power consumption can be reliably reduced.

Further still, an operation means is provided for receiving operation for selectively causing the functional units to work, and, after activation of the other functional units has been prohibited, the control means activates the other functional units when the operation for causing the other functional units to be activated is received by the operation means.

In this way, it is not necessary to lose any ease of use of the image forming apparatus.

Furthermore, the functional units include a printing unit that carries out print processing on a recording paper.

The printing unit is a component for printing images and the like on a recording paper, and its power consumption is large. For this reason, if the printing unit (a functional unit) is activated only when the printing unit is stored in the storage means, there is a larger effect of reducing power consumption.

A display means for displaying multiple screens relating to the functional units is further provided, and, when at least one functional unit is working relating to a screen displayed on the display means immediately prior to power of the image forming apparatus being turned off, the storage means stores identification information of the screen, and when the power of the image forming apparatus is turned on, the control means activates the functional unit relating to the screen of the identification information stored in the storage means.

Thus, if the functional unit relating to the screen of the stored identification information is activated when the power of the image forming apparatus is turned on, the functional unit that was working immediately prior to the power of the image forming apparatus being turned off can be activated.

With an image forming apparatus according to the above configuration, functional units estimated to have a high usage frequency are selectively activated, and increases in power consumption can be suppressed.

### BRIEF DESCRIPTION OF THE DRAWINGS

FIG. 1 is a block diagram showing one embodiment of an image forming apparatus according to the present invention.

FIG. 2A is a diagram showing a screen for setting the details of a copying process and assisting the setting operation.

FIG. 2B is a diagram showing a screen for setting the details of an image data sending process and assisting the setting operation.

FIG. 2C is a diagram showing a screen when powering off the image forming apparatus.

FIG. 3A is a flowchart showing a processing procedure for activating functional units in the image forming apparatus of FIG. 1.

FIG. 3B is a flowchart showing the processing procedure continuing on from FIG. 3A.

FIG. 4 is a diagram that schematically shows a data table in the image forming apparatus of FIG. 1.

### DESCRIPTION OF THE PREFERRED EMBODIMENTS

Hereinafter, embodiments of the present invention are described with reference to the accompanying drawings.

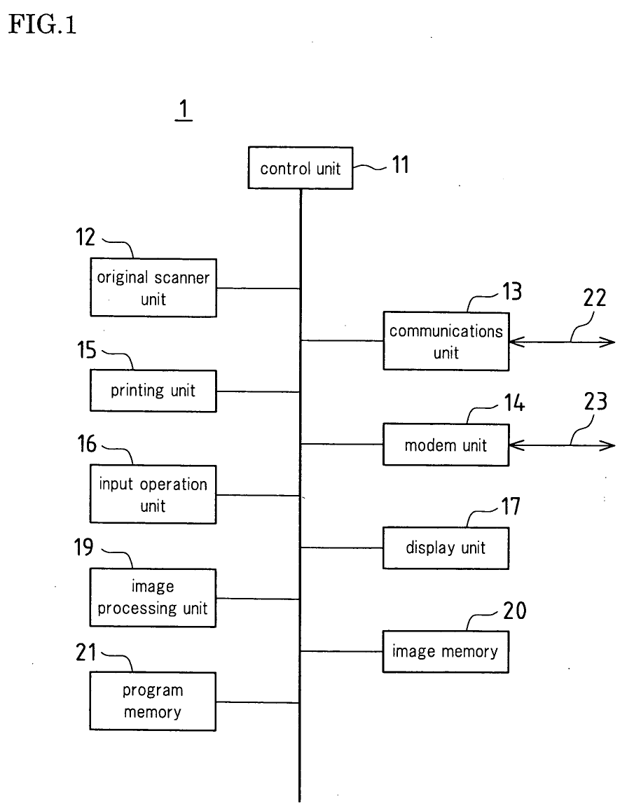

FIG. 1 is a block diagram showing one embodiment of an image forming apparatus according to the present invention. An image forming apparatus 1 according to the present embodiment is a multifunction machine that is capable of selectively executing various types of processing such as copying, original reading, printing, and image data communications, and is provided with units such as a control unit 11, an original scanner unit 12, a communications unit 13, a modem unit 14, a printing unit 15, an input operation unit 16, a display unit 17, an image processing unit 19, an image memory 20, and a program memory 21.

The control unit 11 reads out and executes various programs from the program memory 21 to perform overall control of the image forming apparatus 1.

The original scanner unit 12 reads an original and outputs image data that indicates an image of the original. The communications unit 13 connects via a network 22 to an external terminal (not shown in drawings) such as a personal computer, and sends and receives image data between itself and this external terminal. The modem unit 14 connects via a telephone network 23 to other-party fax terminals (not shown in drawings), and sends and receives image data between itself and these other-party fax terminals. The image memory 20 temporarily stores image data outputted from the original scanner unit 12 and image data that has been received from or is to be sent by the communications unit 13 or the modem unit 14. The image processing unit 19 executes various types of image processing on the image data that is temporarily stored in the image memory 20.

The printing unit 15 prints an image or the like on a recording paper using an electrophotographic method for example. The printing unit 15 forms an image indicated by the image data in the image memory 20 as an electrostatic latent image on a photosensitive structure surface, then develops the electrostatic latent image on the photosensitive structure surface using toner to form a toner image on the photosensitive structure surface, then transfers the toner image from the photosensitive structure surface to a recording paper, and subjects heat and pressure to the recording paper to fix the toner image onto the recording paper.

Furthermore, the printing unit 15 is provided with a paper feeding cassette, in which recording papers are stacked and housed, and a transport mechanism for the recording papers, and the recording papers are withdrawn from the paper feeding cassette to be transported and supplied. Processes such as the transfer of the toner image to the recording paper and the application of heat and pressure to the recording paper are carried out during the transport of the recording paper.

Since the printing unit 15 is provided with components such as the photosensitive structure, a laser scanner that scans the photosensitive structure, a transfer device that transfers the toner image from the photosensitive structure to the recording paper, a fixing device that applies heat and pressure to the recording paper, and a transport mechanism for the recording papers, the power consumption of the printing unit 15 is large compared to the power consumption of other functional units such as the original scanner unit 12 and the communications unit 13. This is mainly because the power consumption of the heater in the fixing device is large.

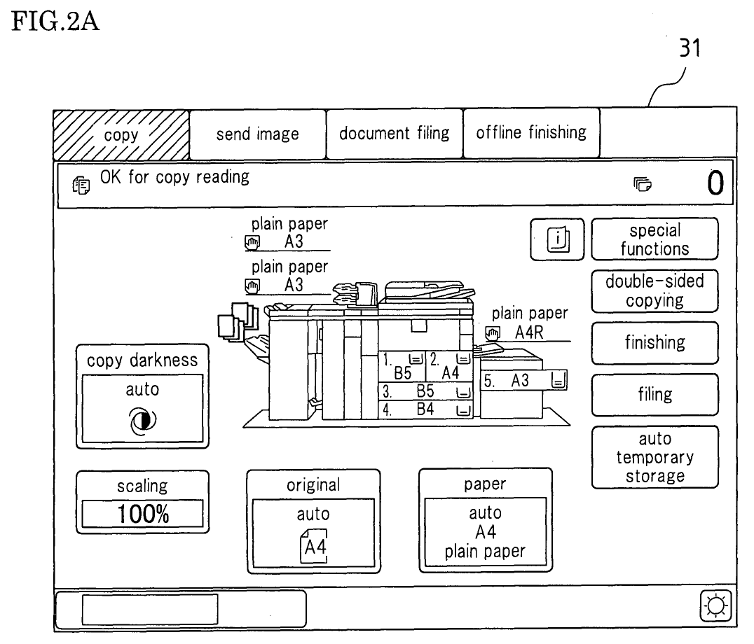

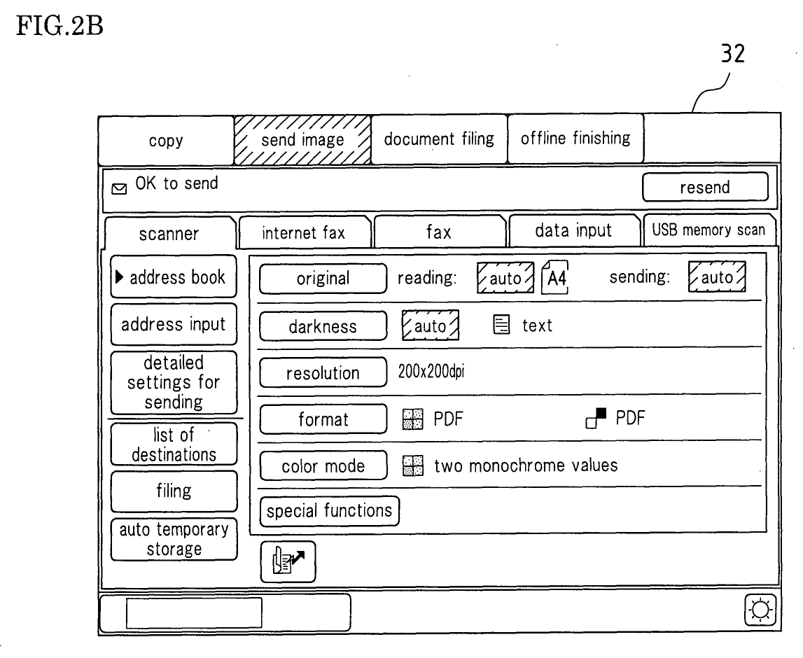

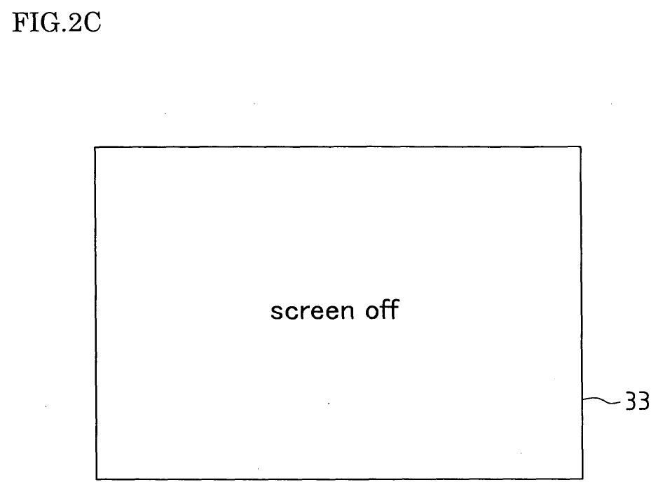

A liquid crystal display device or the like is applicable as the display unit 17. The input operation unit 16 is constituted by keys and buttons operated by the user, or a touch panel or the like provided over the screen of the display unit 17. The control unit 11 displays screens on the display unit 17 for setting the details of processing or for assisting in settings operations for each of the multiple types of processing such as copying, original reading, printing, and image data communications (sending or receiving), and sets the details of the processing in response to the input operations at the input operation unit 16. For example, when performing a copying process, a screen 31 for setting the details of the copying process or for assisting in settings operations is displayed on the display unit 17 as shown in FIG. 2A. And when performing a process of sending image data (a process of receiving image data is set separately), a screen 32 for setting the details of the image data sending process or for assisting in settings operations is displayed on the display unit 17 as shown in FIG. 2B. It should be noted that when the power of the image forming apparatus 1 is turned off and the image forming apparatus 1 is in a stopped state, a screen 33 of the display unit 17 also turns off as shown in FIG. 2C.

Each of the processes of copying, original reading, printing, and image data sending and the like is executed by either one or a combination of the functional units such as the original scanner unit 12, the communications unit 13, the modem unit 14, the printing unit 15, the image processing unit 19, and the image memory 20. For example, the copying process is executed by the original scanner unit 12, which reads the original, the printing unit 15, which prints an image of the original on the recording paper, the image processing unit 19, and the image memory 20 and the like. Accordingly, it is necessary for these functional units to be activated to execute the copying process. Furthermore, the process of sending image data is executed by units such as the original scanner unit 12, the communications unit 13, the modem unit 14, the image processing unit 19, and the image memory 20, and therefore it is necessary for these functional units to be activated.

In this regard, the power consumption of the image forming apparatus 1 is large since it is a multifunction machine having multiple functional units, and thus it is common to aim to achieve power savings. For example, since the power consumption of the printing unit 15 is large, a power-saving mode is set in which the standby time of the image forming apparatus 1 is timed, and when the standby time exceeds a fixed time, the power consumption of the printing unit 15 and the like is reduced, or when the standby time becomes too long, the power of the printing unit 15 is turned off, or further still the power of other functional units is also turned off.

However, conventionally, even when such a power-saving mode is applied, all the functional units are activated when the power of the image forming apparatus 1 is turned on, and therefore wasteful power consumption occurs.

Accordingly, in the present embodiment, when the power of the image forming apparatus 1 is turned on, only the functional unit(s) estimated to have a high usage frequency are selectively activated, thereby aiming to achieve further power savings. The functional unit(s) estimated to have a high usage frequency are the functional unit(s) that were working immediately prior to the power of the image forming apparatus 1 being turned off, and examples of these that can be set forth include the original scanner unit 12, the communications unit 13, the modem unit 14, the printing unit 15, the image processing unit 19, and the image memory 20.

It should be noted that functional units that must be activated when the power of the image forming apparatus 1 is turned on are subject to a default setting. Functional units covered by this default setting include the control unit 11, the input operation unit 16, the display unit 17, and the program memory 21. Furthermore, the turning on and off of the power of the image forming apparatus 1 may be carried out by a manual operation of a power switch, or may be carried out automatically according to a preset time schedule.

Next, description is given of a processing procedure for achieving power savings. First the control unit 11 of the image forming apparatus 1 monitors the screen of the display unit 17 while the image forming apparatus 1 is working, and when a process is executed that has been set via the screen by an operation of the input operation unit 16, identification information of the screen is stored in a nonvolatile memory that is provided in the control unit 11. Then, each time the screen is switched by an operation of the input operation unit 16 to execute a process that has been set via this switched screen, the identification information of the screen in the nonvolatile memory is updated. In this way, when the power of the image forming apparatus 1 is turned off, the identification information of the screen for assisting the setting of the process that was last executed while the image forming apparatus 1 was working is stored in the nonvolatile memory provided in the control unit 11.

When the power of image forming apparatus 1 is turned on in a state in which the identification information of the screen for assisting the setting of the process that was last executed while the image forming apparatus 1 was working is stored in the nonvolatile memory in this manner, the control unit 11, the input operation unit 16, the display unit 17, and the program memory 21 and the like, which are included in the default setting as essential functional units as described earlier, are activated immediately.

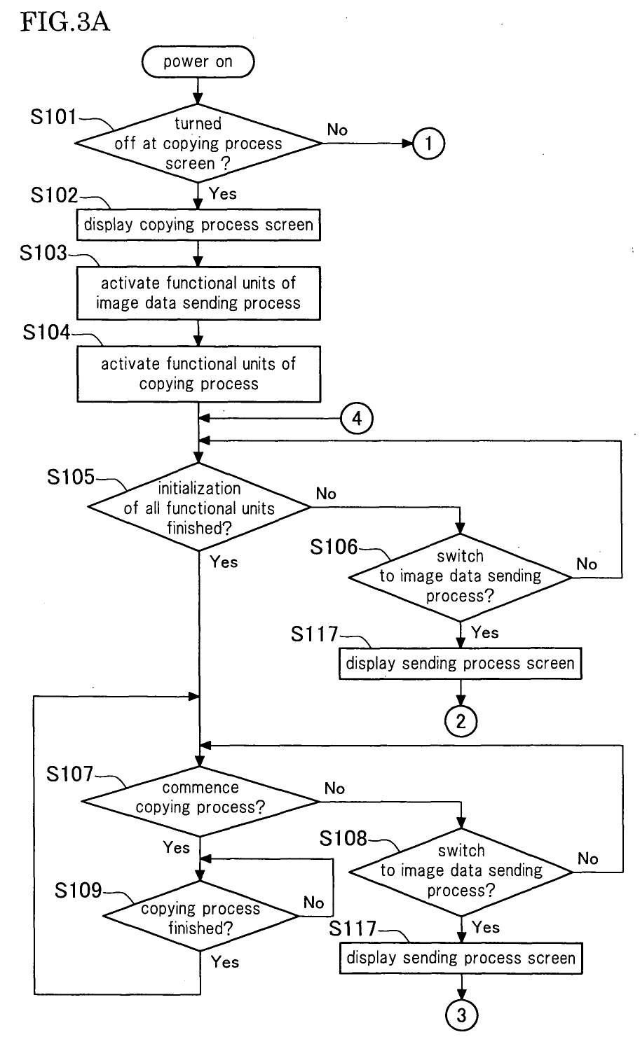

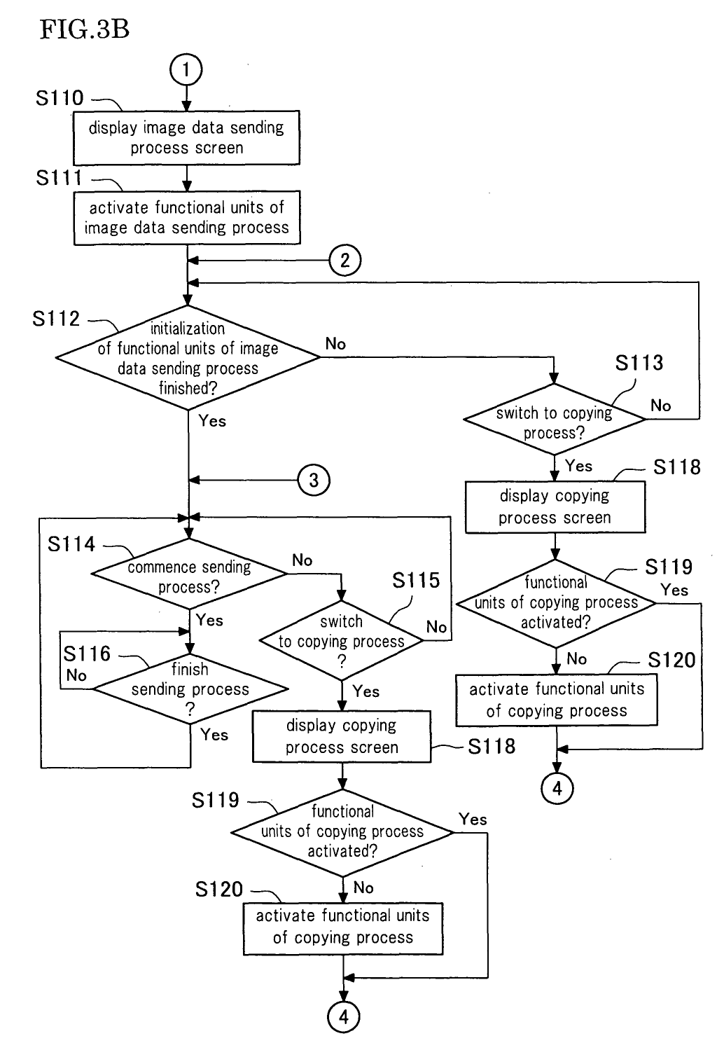

At this time, the control unit 11 reads out from the program memory 21 and executes a program corresponding to the processing procedures of the flowcharts of FIGS. 3A and 3B. Hereon, the processing procedures are described with reference to the flowcharts of FIGS. 3A and 3B. It should be noted that, in order to simplify the description, only a copying process and an image data sending process are set forth in the processing procedures in the flowcharts of FIGS. 3A and 3B.

Upon being activated by a power-on of the image forming apparatus 1, the control unit 11 references the nonvolatile memory of the control unit 11 to obtain the identification information of the screen for assisting the setting of the process that was last executed by the image forming apparatus 1, and determines whether or not the process that was set by this screen and last executed is the copying process (step S101). For example, in a case where the identification information of the screen 31 of FIG. 2A is obtained, it is determined that the process that was set by the screen 31 and last executed is the copying process.

Upon determining that the last executed process is the copying process (yes at step S101), the control unit 11 displays on the display unit 17 the screen 31 of FIG. 2A for assisting the setting of the copying process (step S102). Then, the control unit 11 activates all the other functional units that were not activated as functional units of the default setting when the image forming apparatus 1 was powered on. That is, the original scanner unit 12, the communications unit 13, the modem unit 14, the image processing unit 19, and the image memory 20, which are required to execute the image data sending process, are activated (step S103), and the remaining unit required to execute the copying process, namely, the printing unit 15, is activated even though it is not required to execute the image data sending process (step S104). In this case, all of the functional units of the image forming apparatus 1 are activated.

When all the functional units of the image forming apparatus 1 are turned on, the control unit 11 stands by for initialization of all these functional units to finish (no at step S105), and determines whether or not a change to the image data sending process has been instructed by operation of the input operation unit 16 during the standby (step S106). Then, if the initialization of all the functional units finishes (yes at step S105) while there is no instruction to change to the image data sending process (no at step S106), the control unit 11 stands by for commencement of the copying process to be instructed by operation of the input operation unit 16 (no at step S107), and determines whether or not a change to the image data sending process has been instructed by operation of the input operation unit 16 during the standby (step S108).

Further still, if the commencement of the copying process is instructed (yes at step S107) while there is no instruction to change to the image data sending process (no at step S108), the control unit 11 executes the copying process and stands by for the copying process to finish (no at step S109), and when the copying process finishes (yes at step S109), returns to step S107 and stands by for an instruction of a next copying process commencement.

On the other hand, when the control unit 11 reads out the identification information of the screen for assisting the setting of the process that was last executed from the nonvolatile memory of the control unit 11 upon being activated by a power-on of the image forming apparatus 1 as mentioned earlier, and determines that the process that was set by this screen and last executed is not the copying process (no at step S101), that is, when it is determined that the last executed process is the image data sending process, the screen 32 of FIG. 2B for assisting the setting of the image data sending process is displayed on the display unit 17 (step S110).

Then, the control unit 11 determines the original scanner unit 12, the communications unit 13, the modem unit 14, the image processing unit 19, and the image memory 20, which are required to execute the image data sending process, and activates these functional units (step S111). At this time, the printing unit 15, which is required to execute the copying process, is not activated.

Here, a data table in which the identification information of the screen of the display unit 17 and an identifier of at least one functional unit required to execute the process set by this screen are associated, is stored in advance in the nonvolatile memory of the control unit 11, and it is possible to determine at least one functional unit required to execute the process that was set by this screen and last executed by referencing this data table.

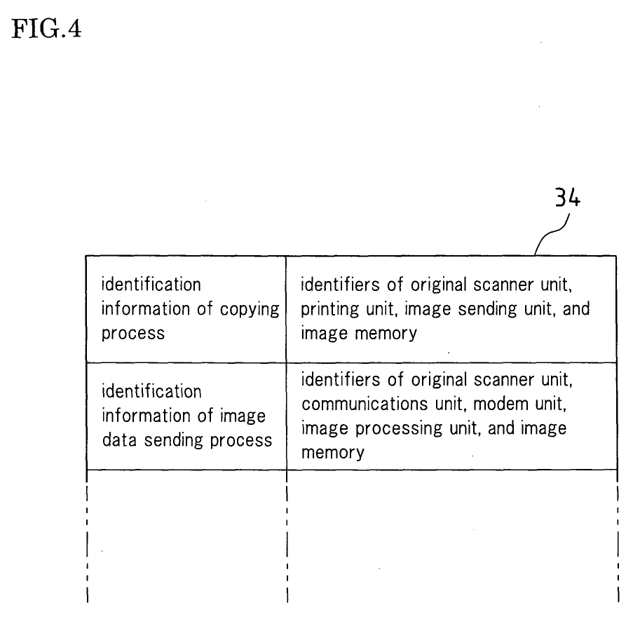

For example, a data table 34 as shown in FIG. 4 is stored. In the data table 34, an identifier is stored of each of the functional units such as the original scanner unit 12, the printing unit 15, the image processing unit 19, and the image memory 20 that are required to execute the copying process corresponding to the identification information of the screen 31 of FIG. 2A, and an identifier is stored of each of the functional units such as the original scanner unit 12, the communications unit 13, the modem unit 14, the image processing unit 19, and the image memory 20 that are required to execute the image data sending process corresponding to the identification information of the screen 32 of FIG. 2B.

Accordingly, the control unit 11 determines the functional units required to execute the image data sending process and the functional units required to execute the copying process by referencing the data table 34, and can activate these functional units.

Furthermore, the identification information of the screen stored in the nonvolatile memory of the control unit 11 is used for deriving at least one functional unit required to execute the process that was set by the screen and last executed, and therefore this functional unit can be considered as being suggested.

When the functional units required to execute the image data sending process are activated, the control unit 11 stands by for the initialization of these functional units to finish (no at step S112), and determines whether or not a change to the copying process has been instructed by operation of the input operation unit 16 during the standby (step S113).

Then, if the initialization of the functional units required to execute the image data sending process finishes (yes at step S112) while there is no instruction to change to the copying process (no at step S113), the control unit 11 stands by for commencement of the image data sending process to be instructed by operation of the input operation unit 16 (no at step S114), and determines whether or not a change to the copying process has been instructed by operation of the input operation unit 16 during the standby (step S115).

Further still, if the commencement of the image data sending process is instructed (yes at step S114) while there is no instruction to change to the copying process (no at step S115), the control unit 11 executes the image data sending process and stands by for the image data sending process to finish (no at step S115), and when the image data sending process finishes (yes at step S115), returns to step S114 and stands by for an instruction of a next image data sending process commencement.

Next, if a change to the image data sending process is instructed by operation of the input operation unit 16 (yes at step S106) during the standby for initialization of all the functional units of the image forming apparatus 1 to finish (no at step S105), then instead of the screen 31 of FIG. 2A, the screen 32 of FIG. 2B for assisting the setting of the image data sending process is displayed on the display unit 17 (step S117), and after this a transition is made to step S112.

Alternatively, if a change to the image data sending process is instructed by operation of the input operation unit 16 (yes at step S108) during the standby for commencement of the copying process to be instructed by operation of the input operation unit 16 (no at step S107), then instead of the screen 31 of FIG. 2A, the screen 32 of FIG. 2B for assisting the setting of the image data sending process is displayed on the display unit 17 (step S117), and after this a transition is made to step S114.

In this case, since it is after activation of the functional units required to execute the image data sending process at step S103, it is not necessary to activate these functional units.

Furthermore, if a change to the copying process is instructed by operation of the input operation unit 16 (yes at step S113) during the standby for initialization of the functional units required to execute the image data sending process to finish (no at step S112), or if a change to copying process is instructed by operation of the input operation unit 16 (yes at step S115) during the standby for commencement of the image data sending process to be instructed by operation of the input operation unit 16 (no at step S114), then instead of the screen 32 of FIG. 2B, the screen 31 of FIG. 2A for assisting the setting of the copying process is displayed on the display unit 17 (step S118).

Then, the control unit 11 references the data table 34 of FIG. 4 to determine the functional units required to execute the copying process, and determines whether or not these functional units are already activated (step S119). At this time, since it is after the functional units required to execute the image data sending process have been activated at step S103 or S111, a determination is performed as to whether or not the remaining unit, namely the printing unit 15, which is required for the copying process although not required for the image data sending process, is activated.

Then, if the printing unit 15 is not activated (no at step S119), then the printing unit 15 is activated (step S120), and if the printing unit 15 is activated (yes at step S119), then step S120 is omitted, and a transition is made to step S105.

In this way, in the present embodiment, identification information of the screen for assisting the setting of the process that was last executed immediately prior to the powering off of the image forming apparatus 1 is stored in the nonvolatile memory of the control unit 11, and when the power of the image forming apparatus 1 is turned on, at least one functional unit required to execute the process of this screen is determined from the identification information of the screen stored in the nonvolatile memory, and this functional unit is activated.

For example, identification information of the screen for assisting the setting of the image data sending process that was last executed immediately prior to the powering off of the image forming apparatus 1 is stored in the nonvolatile, and when the power of the image forming apparatus 1 is turned on, the functional units required to execute the image data sending process is determined from the identification information of the screen stored in the nonvolatile memory, and these functional units are activated. Furthermore, the printing unit 15, which is not required to execute the image data sending process, is not activated. Thus, the large power consumption of the printing unit 15 can be saved.

Furthermore, even though the printing unit 15 is not activated at this time, the printing unit 15 is activated when a change to the copying process is instructed by operation of the input operation unit 16, and therefore there is no loss in the ease of use of the image forming apparatus 1.

Further still, for functional units that are not activated when the power is turned on, when a change of processing is instructed by operation of the input operation unit 16 such that these functional units become required due to the change of processing, these functional units are activated, and therefore it is not necessary to lose any ease of use of the image forming apparatus 1.

It should be noted that the foregoing embodiment was illustrated using the copying process and the image data sending process as examples, but in a case where there is a screen for setting another process and this other process is last executed immediately prior to the powering off of the image forming apparatus 1, the identification information of this screen may be stored, and when the power of the image forming apparatus 1 is turned on, the functional units required to execute this other process can be determined and activated from the stored identification information of the screen.

Furthermore, identification information is stored of the screen for assisting the setting of the process that was last executed immediately prior to the powering off of the image forming apparatus 1, but instead of this, it is possible to store an identifier of the functional units that were working immediately prior to the powering off of the image forming apparatus 1, and when the power of the image forming apparatus 1 is turned on, the functional units of the identifier stored in the nonvolatile memory may be activated.

It should be noted that the present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. Further still, all variations and modifications falling within the equivalency range of the appended claims are intended to be embraced therein.

What is claimed is:

1. An image forming apparatus comprising multiple functional units,
wherein working and non-working of the functional units are switched and set, and
the image forming apparatus comprises:
a storage means for storing, among the functional units, the functional unit that was working immediately prior to power of the image forming apparatus being turned off, and
a control means for activating the functional unit stored in the storage means when power of the image forming apparatus is turned on.

2. The image forming apparatus according to claim 1,
wherein when the power of the image forming apparatus is turned on, the control means prohibits activation of other functional units excluding the functional unit stored in the storage means.

3. The image forming apparatus according to claim 2,
further comprising an operation means for receiving operation for selectively causing the functional units to work,
wherein, after activation of the other functional units has been prohibited, the control means activates the other functional units when the operation for causing the other functional units to be activated is received by the operation means.

4. The image forming apparatus according to claim 1,
wherein the functional units include a printing unit that carries out print processing on a recording paper.

5. The image forming apparatus according to any one of claims 1 to 4,
further comprising a display means for displaying multiple screens relating to the functional units,
wherein, when at least one functional unit is working relating to a screen displayed on the display means immediately prior to power of the image forming apparatus being turned off, the storage means stores identification information of the screen, and
when the power of the image forming apparatus is turned on, the control means activates the functional unit relating to the screen of the identification information stored in the storage means.
